(19) United States
(12) Patent Application Publication
(10) Pub. No.: US 2012/0097592 A1
(43) Pub. Date: Apr. 26, 2012

(54) FLUID TREATMENT FILTER CARDRIDGE WITH HIGH-PRESSURE RESISTANT WOVEN COVER

(76) Inventor: Charles Arthur Rubio, Houston, TX (US)

(21) Appl. No.: 13/095,852

(22) Filed: Apr. 28, 2011

Related U.S. Application Data
(60) Provisional application No. 61/406,126, filed on Oct. 23, 2010.

(51) Int. Cl. B01D 27/00; B01D 35/30

(52) U.S. Cl. 210/232; 210/457; 210/285; 210/458

(57) ABSTRACT

A fluid treatment filtering cartridge having a permeable filtering element and a permeable high-pressure resistant woven tubular fabric external cover formed by a radial weaving loom process that does not use adhesives, thermal bonding or ultrasonic welding techniques is disclosed. The external high-pressure resistant woven cover is secured to end caps of the filter cartridge by adhesives, thermal bonding or ultrasonic welding and surrounds the filter media to form the exterior surface of the filter cartridge and provide both circumferential and longitudinal strength to the filter cartridge in order for it to withstand internal pressures exceeding 250 psi.

### CROSS REFERENCE TO RELATED APPLICATION

This application claims priority of U.S. Provisional Application Ser. No. 61/406,126, filed on Oct. 23, 2010.

### BACKGROUND OF THE INVENTION

1. Field of the Invention

This invention relates generally to fluid treatment filtering cartridges and elements and, more particularly, to a permeable fluid treatment filtering cartridge having a permeable exterior high-pressure resistant woven fabric cover that surrounds the filtering element allows fluid flow from an internal center to the outer surface of the fluid treatment cartridge, and method of manufacture thereof.

2. Background Art

Conventional fluid treatment and filtering cartridges and filtering elements of the type used in various fields, including, for example, filtration, water demineralization, and gas treatment, typically comprise a hollow, generally cylindrical, permeable cartridge and an end cap positioned on each end of the cartridge to direct a fluid, i.e., a gas or a liquid, through the cartridge filtering element or filtering medium. In a typical cylindrical pleated filter element, a plurality of pleats are arranged around a tubular core to define a cylinder. As viewed in a transverse cross-section, the individual pleats of such a filter element extend radially outward from the core toward the outer periphery of the filter element. The matrix of the pleated filter material may be formed of fibrous material bonded to a substrate and/or mechanically bonded by mechanical entanglement of the fibers of the filter matrix and the substrate, forming a composite filter medium. The substrate supports the filter matrix against differential pressure across the filter matrix.

A precoat filter is a type of filter that utilizes an applied filter medium in which a slurry is applied to the exterior of a porous support structure called a septum to form a filter cake. The precoat can be a granular material, such as diatomaceous earth, perlite or cellulose fibers. Depending on the specific treatment to be given the fluid, the porous filtering element or filter medium of the cartridge may, for example, include a filter medium for removing particulates or a demineralizer or sorbent for separating ionic or chemical components.

Frequently, the fluid is forced to flow outwardly from the interior to the exterior of the hollow, permeable cartridge. This “inside-out” flow may be the normal direction of flow through the filter element, because it may have certain advantages. For example, many filters have a graded porosity with the coarsest pores on the upstream portion of the filter and the finest pores on the downstream portion of the filter. If the normal direction of flow is “inside-out”, the downstream portion of the cartridge where the pores are finest is the exterior portion of the cartridge where the diameter of the cartridge is greatest. This configuration helps to reduce the pressure drop across the finest porosity portion of the filter.

However, even if the normal direction of flow is “inside-out”, the direction of flow may occasionally be reversed to “outside-in”. This reversal of the normal flow may be accidental, e.g., due to a surge in fluid pressure downstream from the filter element, or it may be intentional, e.g., to flush an accumulated cake of particulate matter from a tubular cover which covers the external surface of the fluid treatment cartridge.

Whenever the fluid flow is from inside-to-outside (“inside-out”) through the permeable cartridge, the fluid exerts an outwardly-directed force on the exterior of the cover of the cartridge. If this force is large enough, the cartridge may distend, distort, rupture, or even burst, thereby reducing the efficiency of the cartridge or even rendering the cartridge totally ineffective. Many high efficiency fluid treatment cartridges characterized by low resistance to “inside-out” flow include a medium of fibers that are not tightly bonded to one another. The force required to distort such a cartridge may be relatively small. The use of covers comprising external wraps and hard shell walls does not deal with these internal pressures adequately.

Current fluid treatment cartridge external covering is based on a wrapping process that involves wrapping the external surface of the cartridge filter in spirally wound successive overlapping windings about the external surface of the cartridge. The spiral wrap surrounds the filter element and forms the external surface of the cartridge.

Degen et al, U.S. Pat. No. 4,882,056 is an example of a spiral wrap with successive overlapping windings about the external surface of the cartridge which utilizes adhesives between overlapping windings of the wrap in order to provide structural integrity. An end cap is disposed over an end of the cartridge and is secured to the end of the cartridge and an end portion of the wrap.

This wrapping technology is not generally acceptable in the industry because of extensive use of adhesives including applying adhesives between the external wrapping and the filtration media within the fluid treatment cartridge. It is practically mandatory, when using the spiral wound external wrapping, to have a filter core tube in the center of the filter cartridge attached to the end caps in order to provide radial and longitudinal support which is not provided by the spirally wound wrap. Some prior at wrapping techniques also require that the wrap be positively fastened, such as by adhesives, to the internal filter media of the cartridge in order to prevent it from stretching and ballooning away.

Miller et al, U.S. Pat. No. 5,252,207; Stoyell et al, U.S. Pat. No. 5,690,765; and Geibel et al, U.S. Pat. Nos. 5,725,784 and 5,876,601; are other examples of filter cartridges having filter core tube in the center of the cartridge and a spiral wrap with successive overlapping windings about the external surface of the cartridge.

Hartmann, U.S. Pat. No. 6,739,459 discloses another current technology which utilizes extruded or knitted plastic tubes as the outer wall. The filter element includes a hollow filter pack, a core disposed in the filter pack, and an end cap. The core has a wall structure and a recess. The end cap is bonded to the filter, and solidified bonding material produced during bonding of the end cap to the filter pack is contained in the recess of the core. The wall structure of the core supports the periphery of the filter pack at the bond. The drawback in the use of this method of providing an external covering is that due to the hard rigid nature of the outer wall, the internal pressure capacity is severely limited since the greater the internal pressure, the greater the thickness of the outer wall. A thick external hard plastic outer wall reduces the available amount of filtration media area within cartridge filter since the filtration media volume in cartridge filters is governed by their outside diameter. Another disadvantage of this technology is due to the hard rigid materials, shipment and transportation costs are extremely high since there is no reduction in shipping volume.

De Laski, U.S. Pat. No. 653,919; Nicewarner, U.S. Pat. No. 1,164,303; and Cole, U.S. Pat. No. 2,475,012; all of which are incorporated herein by reference, are examples of weaving technologies employed in producing woven fabric tubes and woven tubular flexible hoses, such as fire hoses.

### SUMMARY OF THE INVENTION

The present invention overcomes the aforementioned problems and is distinguished over the prior art in general, and these patents in particular, by a fluid treatment filtering cartridge having a permeable filtering element and a permeable high-pressure resistant woven tubular fabric external cover formed by a radial weaving loom process that does not use adhesives, thermal bonding or ultrasonic welding techniques. The external high-pressure resistant woven cover is secured to end caps of the filter cartridge by adhesives, thermal bonding or ultrasonic welding and surrounds the filter media to form the exterior surface of the filter cartridge and provide both circumferential and longitudinal strength to the filter cartridge in order for it to withstand internal pressures exceeding 250 psi.

One of the significant features and advantages of the present invention is that the external high-pressure resistant woven cover provides both circumferential and longitudinal strength to the filter cartridge in order for it to withstand internal pressures exceeding 250 psi.

Another significant feature and advantage of the present invention is that the external high-pressure resistant woven cover can be secured to the end caps disposed at the ends of the cartridge so as not to leave exposed portions of the cartridge unsupported against outwardly-directed forces of the fluid being filtered.

Another significant feature and advantage of the present invention is that the external high-pressure resistant woven cover provides both circumferential and longitudinal cartridge strength and thereby may eliminate the requirement for internal core tubes and external perforated hard tubes to provide cartridge structural integrity.

Another significant feature and advantage of the present invention is that the external high-pressure resistant woven cover resists extremely high internal pressure caused by the filter pressure drop as the filter becomes clogged, thus can extend the useful life and operating safety factors of the filter by minimizing frequent change-outs and increase the allowable pressure drop of the cartridge.

Another significant feature and advantage of the present invention is that the external high-pressure resistant woven cover is tubular and continuous from end cap to end cap along the entire external surface of the permeable filtering element and more effectively withstands outwardly-directed forces of a fluid flowing inside-out through the element as well as the inwardly-directed forces of a fluid flowing outside-in.

Another significant feature and advantage of the present invention is that the external high-pressure resistant woven cover will not allow stretching and ballooning away from the cartridge, even after prolonged exposure to outwardly-directed forces of a fluid flowing inside-out through the element and thus, the cover remains tightly around the cartridge, firmly supporting the cartridge against outwardly-directed forces of the fluid.

A further significant feature and advantage of the present invention is that the external high-pressure resistant woven cover can be folded flat and shipped in large continuous rolls, thus minimizing storage area during the process of manufacturing and shipping, and well as reducing shipping and transportation volume and costs.

A still further significant feature and advantage of the present invention is that the external high-pressure resistant woven cover is simple in construction, inexpensive to manufacture, and rugged and reliable in operation.

Other features and advantages of the invention will become apparent from time to time throughout the specification and claims as hereinafter related.

### BRIEF DESCRIPTION OF THE DRAWINGS

FIG. 1 is a perspective view of a fluid treatment cartridge in accordance with the present invention.

FIG. 2 is an enlarged cross sectional view of the upper portion of the fluid treatment cartridge of FIG. 1, showing the filter element and high-pressure external woven cover secured to the end cap by thermal bonding.

FIG. 3 is an enlarged cross sectional view of the upper portion of the fluid treatment cartridge having a core tube, showing the filter element and core tube secured to the end cap by thermal bonding and the high-pressure external woven cover secured to the end cap by ultrasonically welding.

FIG. 4 is an enlarged cross sectional view of the upper portion of the fluid treatment cartridge having a core tube, showing the filter element, the core tube, and the high-pressure resistant external woven cover secured to the end cap by thermal bonding.

FIGS. 5 and 6 are partial elevation views of a portion of the high-pressure resistant tubular woven cover made in a loom.

FIG. 7 is an enlarged transverse cross sectional view of a single jacket high-pressure resistant woven cover showing, schematically, interwoven single warp and single weft threads.

FIG. 8 is an enlarged transverse cross sectional view of a modified single jacket high-pressure resistant woven cover showing, schematically, interwoven single warp and pairs of weft threads.

FIG. 9 is an enlarged transverse cross sectional view showing, schematically, a double jacket high-pressure resistant woven cover.

FIG. 10 is a transverse cross sectional view showing the high-pressure resistant woven cover encircling the fluid filter element.

FIG. 11 is a transverse cross sectional view of the high-pressure resistant woven cover folded for transportation and shipping.

### DESCRIPTION OF THE PREFERRED EMBODIMENTS

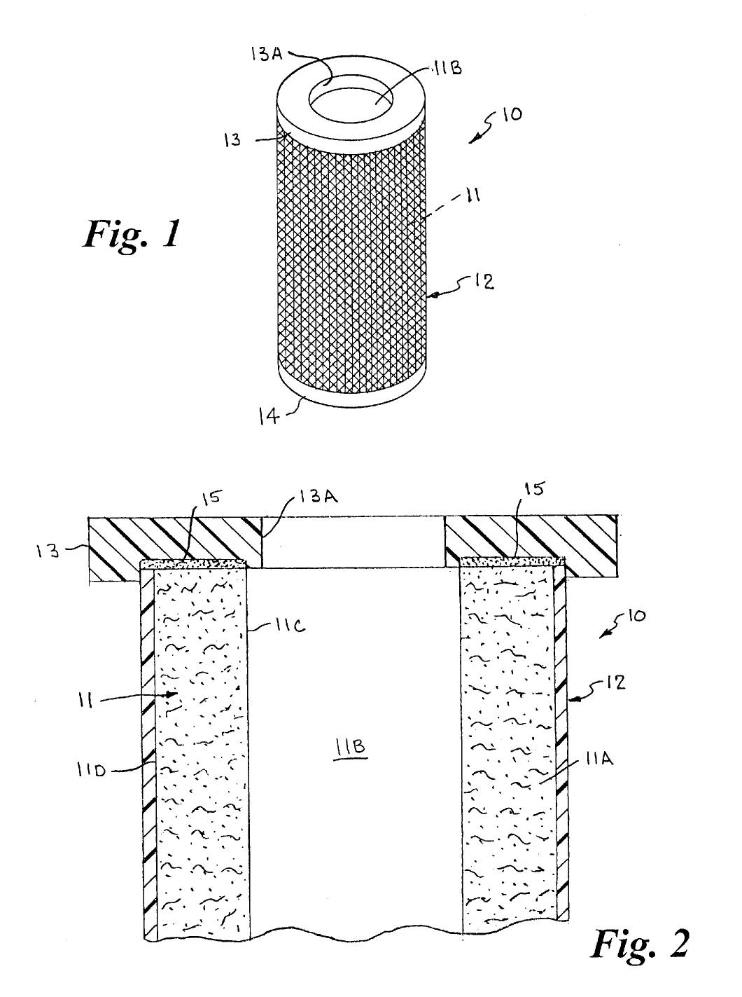

Referring to the drawings by numerals of reference, there is shown in FIG. 1, an exemplary fluid treatment cartridge 10 in accordance with the present invention. The fluid treatment cartridge 10 has a generally cylindrical configuration having a filter element 11 surrounded by an external high-pressure resistant woven cover 12, which is shown somewhat schematically in FIG. 1, but shown and described in greater detail hereinafter. The cartridge 11 further includes an open end cap 13 and a blind end cap 14 positioned at the opposed ends of the filter element 11. The open end cap 13 includes an opening 13A which communicates with a central longitudinal cavity 11B of the filter element 11 within the cartridge 10. Alternatively, both end caps 13, 14, may be open end caps, allowing several cartridges to be physically connected end-to-end.

The filter element 11 provides the primary treatment for fluid flowing through the fluid treatment cartridge 10 while the external high-pressure resistant woven cover 12 provides circumferential and longitudinal structural support for the cartridge and filter element, as described in greater detail hereinafter. More particularly, the external high-pressure resistant woven cover 12 provides additional strength, including, for example, additional hoop strength, to resist the various forces exerted on the filter element 11 by fluids flowing outside-to-inside or inside-to-outside through the cartridge 10. Additionally, the external high-pressure resistant woven cover 12 may provide a pre-treatment or post-treatment of the fluid. By varying weaving and thread densities, the external high-pressure resistant woven cover 12 provides controlled pressure drop. The cartridge 10 with the external high-pressure resistant woven cover 12 surrounding the filtering element 11 and secured to the end caps 13 and 14 is extremely strong.

Referring additionally to FIG. 2, the fluid treatment filter element 11 of the cartridge 10 may be variously configured, depending on the specific treatment to be given the fluid. For example, in the exemplary fluid treatment cartridge of 10 of FIG. 2, the filtering element 11 is shown to be a hollow generally cylindrical configuration having a central longitudinal cavity 11B, although it may have any other suitable hollow configuration. In this example, the filter element 11 does not have a center tube. However, it should be understood that the cartridge may have a center core made of a rigid or flexible perforated tubular member or may be “coreless” (having no core). The external high-pressure resistant woven cover 12 covers the filter element 11 and it is secured to the end cap 13 by thermal bonding. In the illustrated example of FIG. 2, the filter media 11A may be formed of a granular material, such as diatomaceous earth, perlite or cellulose fibers. Depending on the specific treatment to be given the fluid, the porous filter element 11 or filter medium 11A of the cartridge 10 may, for example, include a filter medium for removing particulates or a demineralizer or sorbent for separating ionic or chemical components.

The cavity 11B of the filter element 11 of the fluid treatment cartridge 10 includes an interior surface 11C and an exterior surface 11D that is surrounded by the external high-pressure resistant woven cover 12 which provides superior strength to readily resist outwardly-directed forces exerted on the filter medium 11A or any significant pressure drop between the inside and the outside of the filter medium. Alternatively, the filtering element 11 of the fluid treatment cartridge 10 may comprise any other suitable filter medium 11A, multiple layers of a single filter medium, or multiple filter media, and or pleated media.

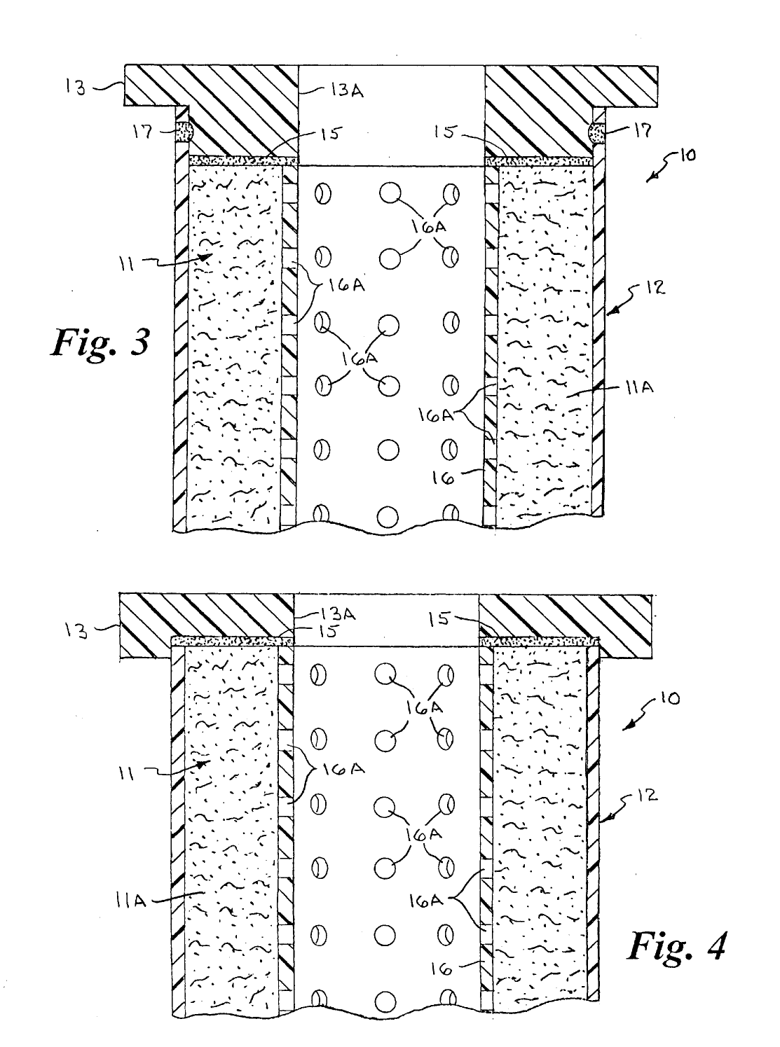

FIG. 3 shows the upper portion of a fluid treatment cartridge 10 which has a center core made of a rigid or flexible perforated tubular member 16 provided perforations 16A surrounded by the filter element 11 and/or filtering media 11A. The external high-pressure resistant woven cover 12 surrounds the filter element 11 and/or filtering media 11A. In this example, the external high-pressure resistant woven cover 12 is attached to the end cap 13 using by ultrasonic welding 17 and the perforated core tube 16 and filter element 11 and/or filtering media 11A are secured to the end cap by thermal bonding 15. It should be understood that the opposed ends of the cover 12 and the perforated core tube 16 and filter element 11 and/or filtering media 11A are secured to the opposed end cap 14 in the same manner. It should also be understood that cartridges having a center core made of a rigid or flexible perforated tubular member may also utilize a pleated filtering element 11 having a plurality of longitudinal pleats arranged around the tubular core, with the individual pleats of such a filter element extending radially outward from the core

FIG. 4 shows the portion of a fluid treatment cartridge 10 which has a center core made of a rigid or flexible perforated tubular member 16 provided perforations 16A surrounded by the filter element 11 and/or filtering media 11A. The external high-pressure resistant woven cover 12 surrounds the filter element 11 and/or filtering media 11A. In this example, both, the external high-pressure resistant woven cover 12 and the filter element 11 and/or filtering media 11A are secured to the end cap 13 by thermal bonding 15. It should be understood that the opposed ends of the cover 12 and the perforated core tube 21 and filter element 11 and/or filtering media 11A are secured to the opposed end cap 14 in the same manner. It should also be understood that cartridges having a center core made of a rigid or flexible perforated tubular member may also utilize a pleated filtering element 11 having a plurality of longitudinal pleats arranged around the tubular core, with the individual pleats of such a filter element extending radially outward from the core.

Although the external high-pressure resistant woven cover 12 has been described as being attached to the end caps 13, 14 of the filter cartridge 10, it should be understood that the external high-pressure resistant woven cover 12 may be attached to the end caps by adhesives and other conventional fastening means, and that the cover 12 may optionally be fastened to the exterior of the filter element or filter media by adhesives, thermal bonding, or ultrasonic welding or various other conventional fastening means.

The external high-pressure resistant woven cover 12 provides additional strength, in particular, hoop strength, to support the cartridge 10 and filter element 11 without any sacrifice in pressure drop. As an example, the external high-pressure resistant woven cover provides sufficient hoop strength to prevent permanent damage to the fluid treatment cartridge 10 and filter element 11 during inside-out flow with a 250 psid (Pressure Differential) pressure drop across the filter element 11. At the same time the pressure drop across the external high-pressure resistant woven cover 12 is preferably less than 15% and most preferably less than 10% of the pressure drop which would exist across the cartridge if there were no external high pressure resistant woven cover 12.

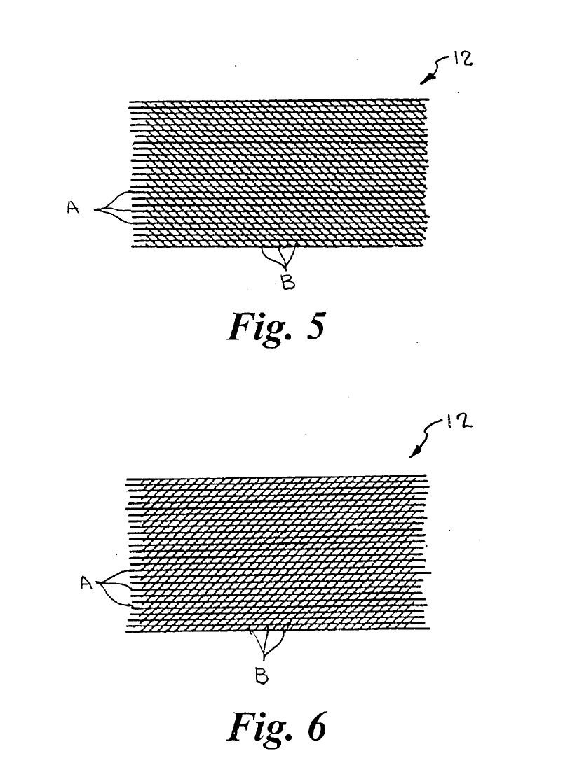

Referring now to FIGS. 5-11, the present external high-pressure resistant woven cover 12 is shown somewhat schematically and described in detail. The external high-pressure resistant woven cover 12 for the exterior surface of the cartridge 10 may be woven from a variety of materials including polymers, such as polyester, polyamide, polyacrylonitrile, or polyolefins, such as polyethylene or polypropylene. Alternatively, the material may comprise a woven material such as a metal wire, carbon fiber yarn, Kevlar®, aramid, fiberglass, or other suitable materials. The external high-pressure resistant woven cover 12 may typically be continuous with no seams and is made specifically to surround the outside diameter of the filter element 11 and serve as the external surface of the cartridge 10.

FIGS. 5 and 6 show, schematically, exterior portions of the external high-pressure resistant woven cover 12 made of a woven tubular fabric wherein the threads of the fabric are represented schematically by straight lines and diagonal lines. For purposes of simplicity and ease of understanding the lines are not illustrated as interwoven. The straight lines “A” represent the warp threads, and the diagonal lines “B” represent the weft threads. The weft-threads are inclined or diagonal, as shown, with regard to the warp threads. The advantage of diagonal weft threads is that the tubular fabric is more flexible and can be easily folded.

It should be understood that the threads of the fabric are interwoven by a conventional loom used for radial weaving of tubular fabrics wherein shuttle or shuttles of the loom move in an inclined or diagonal direction relatively to the longitudinal warp threads. In cases where one tubular fabric cover is placed concentrically within another, the weft threads “B” of the tubular fabrics may be oriented at an angle to each other so as to cross. This arrangement provides greater strength without increasing the weight of the cover.

In a preferred embodiment, no adhesives, thermal bonding or ultrasonic welding operations are utilized in the process of forming the external high-pressure resistant woven cover 12; however, the tubular woven cover may be securely fastened to the end caps 13, 14 of the filter cartridge 10 by adhesives, thermal bonding, or ultrasonic welding and may be optionally fastened to the filter element 11 or filter media 11A by various fastening means conventional in the art. Preferably, the external high-pressure resistant woven cover 12 is secured to the end caps disposed at the ends of the cartridge so as not to leave any exposed portions of the cartridge unsupported against outwardly-directed forces of the fluid.

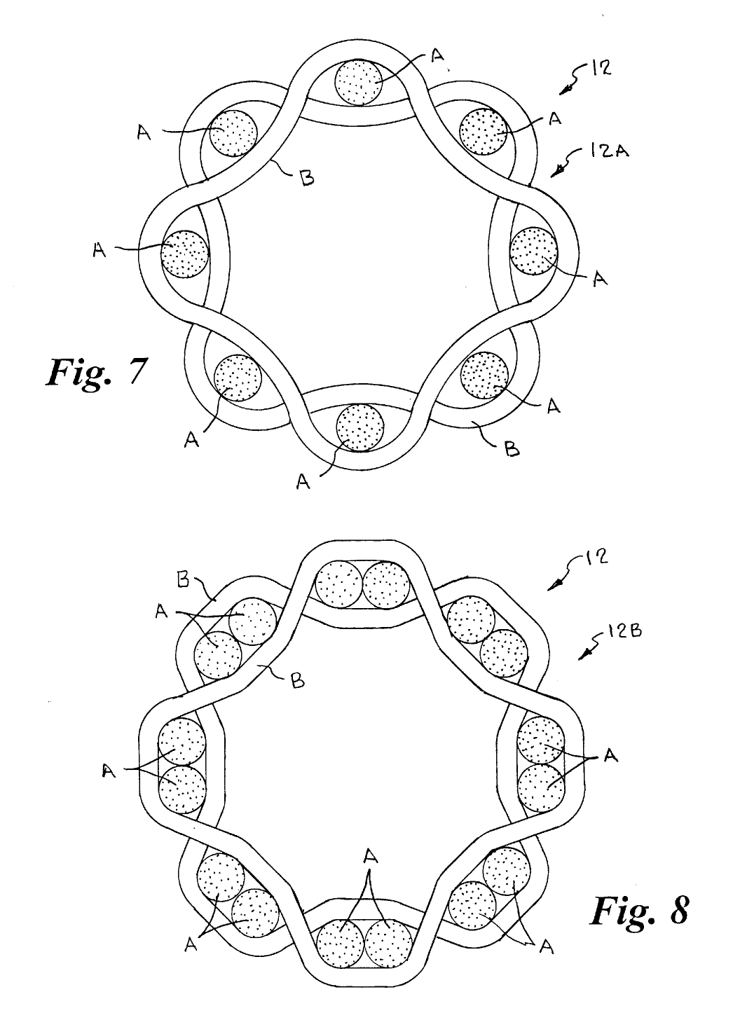

FIG. 7 shows an enlarged transverse cross sectional view of a single jacketed external high-pressure resistant woven cover 12 which is formed as a single jacket 12A. The jacket 12A is woven on a loom and comprises single warp threads A and weft threads B. The warp threads A run longitudinally with respect to the completed jacket. The weft threads B run helically along the completed jacket.

FIG. 8 shows an enlarged transverse cross sectional view of a modified single jacketed external high-pressure resistant woven cover 12 which is formed as a single jacket 12B. The modified jacket 12B is woven on a loom and comprises pairs of warp threads A that run longitudinally with respect to the completed jacket and single weft threads B that run helically along the completed jacket.

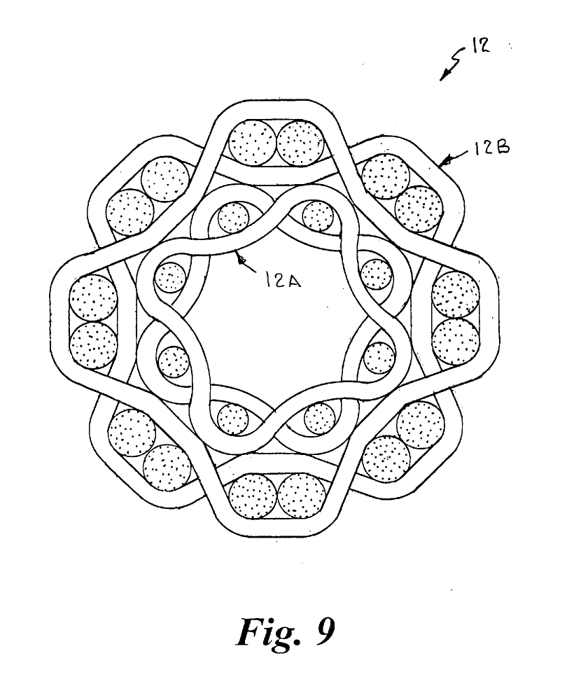

FIG. 9 illustrates, schematically, a double jacket high-pressure resistant woven cover 12 which is formed by a combination of the two single jacketed external high-pressure resistant woven covers 12A and 12B, shown and described in FIGS. 7 and 8, one inside the other. It should be understood that the double jacket high-pressure resistant woven cover 12 may be formed by a combination of two of the single jacketed external high-pressure resistant woven covers 12A that utilize single warp and weft threads (FIG. 7), or by a combination of two of the single jacketed external high-pressure resistant woven covers 12B that utilize double warp and single weft threads (FIG. 8). It should also be understood that the external high-pressure resistant woven cover 12 may be formed of more than two concentric jacket configurations, disposed one inside the other.

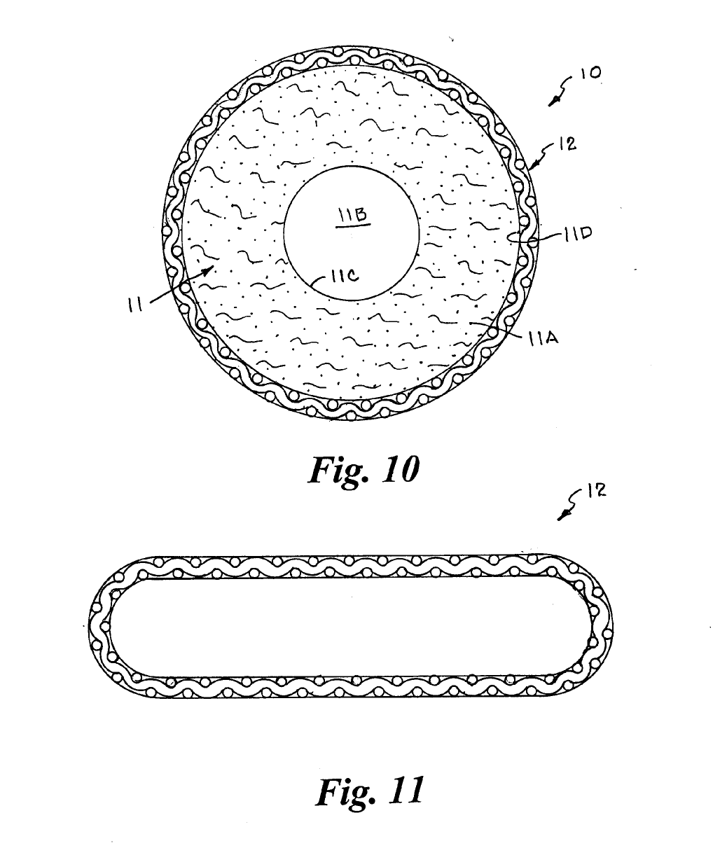

As shown in FIG. 10, the high-pressure resistant woven cover 12 encircles and covers the filter element 11 or filter media 11A of the fluid treatment cartridge 10 to provide internal pressure retaining characteristics while allowing the incoming fluid to enter through the central cavity or core tube.

As shown in FIG. 11 the high-pressure resistant woven cover 12 can be folded into a flat configuration during the process of manufacturing to conserve storage area as well as reducing shipping and transportation volume, and costs.

It should be understood that, because the external high-pressure resistant woven cover 12 is tubular and continuous from end cap to end cap along the entire external surface of the filtering element, it provides both circumferential and longitudinal cartridge strength, and the requirement for internal core tubes and external perforated hard tubes to provide cartridge structural integrity may be eliminated. The present external high-pressure resistant woven cover effectively prevents stretching and ballooning away from the cartridge, even after prolonged exposure to outwardly-directed forces due to fluid flowing inside-out through the filter element, and the cover remains tightly around the cartridge. Filter cartridges employing the high-pressure resistant woven cover are capable of effectively withstanding outwardly-directed forces of a fluid flowing inside-out through the filter element as well as the inwardly-directed forces of a fluid flowing outside-in.

The present external high-pressure resistant woven cover also resists extremely high internal pressure caused by the filter pressure drop as the filter becomes clogged, thus can extend the useful life and operating safety factors of the filter by minimizing frequent change-outs and increase the allowable pressure drop of the cartridge.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

1. A fluid filtering cartridge for treatment or filtering fluids, comprising:
a generally cylindrical longitudinal filter element formed of a porous fluid filter medium having a central longitudinal center cavity and an outer diameter;
end caps at opposed ends of said filter element with at least one of said end caps provided an aperture for fluid flow therethrough into said center cavity of said filter element; and
a porous external high-pressure resistant woven cover surrounding said filter element outer diameter and secured at opposed ends to said end caps; wherein
fluid under pressure flows through said filter element from said center cavity to the outer diameter thereof and through said external high-pressure resistant woven cover; and
said external high-pressure resistant woven cover provides circumferential and longitudinal structural support for said cartridge and said filter element to resist differential pressure forces exerted on said filter element by fluids flowing from said center cavity to the outer diameter thereof and through said external high-pressure resistant woven cover and by fluids flowing from the exterior of said cartridge through said external high-pressure resistant woven cover, said filter element, and into said center cavity.

2. The fluid filtering cartridge for treatment or filtering fluids according to claim 1, wherein
said porous fluid filter medium of said filter element comprises a medium selected from the group consisting of granular materials, fibrous materials, and pleated filter media.

3. The fluid filtering cartridge for treatment or filtering fluids according to claim 1, wherein
said porous fluid filter medium of said filter element includes means for separating ionic or chemical components in the fluid selected from the group consisting of demineralizers and sorbents.

4. The fluid filtering cartridge for treatment or filtering fluids according to claim 1, wherein
said central longitudinal center cavity of said filter element is defined by a central longitudinal tubular member having an interior surrounded by a perforated side wall and opposed ends secured to said end caps, in fluid communication with said aperture of said at least end cap for allowing fluid to flow into said interior, through said filter element, and through said porous external high-pressure resistant woven cover.

5. The fluid filtering cartridge for treatment or filtering fluids according to claim 4, wherein
said porous fluid filter medium of said filter element comprises a medium selected from the group consisting of granular materials, fibrous materials, and pleated filter media.

6. The fluid filtering cartridge for treatment or filtering fluids according to claim 4, wherein
said porous fluid filter medium of said filter element includes means for separating ionic or chemical components in the fluid selected from the group consisting of demineralizers and sorbents.

7. The fluid filtering cartridge for treatment or filtering fluids according to claim 4, wherein
said porous fluid filter medium of said filter element comprises a pleated filtering element having a plurality of longitudinal pleats surrounding said central longitudinal tubular member with individual pleats extending generally radially outward therefrom to form a generally cylindrical configuration.

8. The fluid filtering cartridge for treatment or filtering fluids according to claim 1, wherein
said external high-pressure resistant woven cover is woven from materials selected from the group consisting of polymers, polyester, polyamide, polyacrylonitrile, polyolefins, polyethylene, polypropylene, metal wire, carbon fiber yarn, Kevlar®, aramid, and fiberglass.

9. The fluid filtering cartridge for treatment or filtering fluids according to claim 1, wherein
said external high-pressure resistant woven cover is woven to be a continuous tubular configuration with no seams.

10. The fluid filtering cartridge for treatment or filtering fluids according to claim 1, wherein
said external high-pressure resistant woven cover is formed of a woven fabric wherein the warp threads are generally parallel, and the weft threads are inclined or diagonal with respect to the warp threads.

11. The fluid filtering cartridge for treatment or filtering fluids according to claim 1, wherein
said external high-pressure resistant woven cover is a single jacket tubular configuration formed of a woven fabric wherein single warp threads run longitudinally, and the weft threads run helically with respect to the warp threads.

12. The fluid filtering cartridge for treatment or filtering fluids according to claim 1, wherein
said external high-pressure resistant woven cover is a single jacket tubular configuration formed of a woven fabric wherein pairs of warp threads run longitudinally, and single weft threads run helically with respect to the warp threads.

13. The fluid filtering cartridge for treatment or filtering fluids according to claim 1, wherein
said external high-pressure resistant woven cover comprises a first and a second tubular jacket configuration, one disposed concentrically inside of the other, each formed of a woven fabric, wherein single warp threads run longitudinally and the weft threads run helically with respect to the warp threads, with the weft threads of said first jacket and second jacket extending helically in opposite directions with respect a longitudinal axis.

14. The fluid filtering cartridge for treatment or filtering fluids according to claim 1, wherein
said external high-pressure resistant woven cover comprises a first and a second tubular jacket configuration, one disposed concentrically inside of the other, each formed of a woven fabric, wherein pairs of warp threads run longitudinally and single weft threads run helically with respect to the warp threads, with the weft threads of said first jacket and second jacket extending helically in opposite directions with respect a longitudinal axis.

15. The fluid filtering cartridge for treatment or filtering fluids according to claim 1, wherein
said external high-pressure resistant woven cover comprises a first and a second tubular jacket configuration, one disposed concentrically inside of the other;
said first tubular jacket formed of a woven fabric, wherein single warp threads run longitudinally and the weft threads run helically with respect to the warp threads;
said second tubular jacket formed of a woven fabric, wherein pairs of warp threads run longitudinally and single weft threads run helically with respect to the warp threads; and
said weft threads of said first jacket and second jacket extend helically in opposite directions with respect a longitudinal axis.

16. The fluid filtering cartridge for treatment or filtering fluids according to claim 1, wherein
said high-pressure resistant woven cover is sufficiently flexible and capable of being folded into a generally flat configuration prior to surrounding said filter element.

17. A porous high-pressure resistant woven cover for surrounding a generally cylindrical filter element of a filter cartridge, comprising;
a high-pressure resistant woven cover having a continuous tubular configuration with no seams and sufficiently flexible and capable of being folded into a generally flat configuration prior installation on the filter element;
said high-pressure resistant woven cover adapted to be installed on the exterior of the filter element to provide circumferential and longitudinal structural support for the cartridge and the filter element and to resist differential pressure forces exerted on the filter element by fluids flowing from inside of the filter element to the outside thereof and by fluids flowing from the exterior of the cartridge to the inside of the filter element.

18. The porous high-pressure resistant woven cover according to claim 17, wherein
said high-pressure resistant woven cover is woven from materials selected from the group consisting of polymers, polyester, polyamide, polyacrylonitrile, polyolefins, polyethylene, polypropylene, metal wire, carbon fiber yarn, Kevlar®, aramid, and fiberglass.

19. The porous high-pressure resistant woven cover according to claim 17, wherein
said external high-pressure resistant woven cover is formed of a woven fabric wherein the warp threads are generally parallel, and the weft threads are inclined or diagonal with respect to the warp threads.

20. The porous high-pressure resistant woven cover according to claim 17, wherein
said external high-pressure resistant woven cover is a single jacket tubular configuration formed of a woven fabric wherein single warp threads run longitudinally, and the weft threads run helically with respect to the warp threads.

21. The porous high-pressure resistant woven cover according to claim 17, wherein
said external high-pressure resistant woven cover is a single jacket tubular configuration formed of a woven fabric wherein pairs of warp threads run longitudinally, and single weft threads run helically with respect to the warp threads.

22. The porous high-pressure resistant woven cover according to claim 17, wherein
said external high-pressure resistant woven cover comprises a first and a second tubular jacket configuration, one disposed concentrically inside of the other, each formed of a woven fabric, wherein single warp threads run longitudinally and the weft threads run helically with respect to the warp threads, with the weft threads of said first jacket and second jacket extending helically in opposite directions with respect a longitudinal axis.

23. The porous high-pressure resistant woven cover according to claim 17, wherein
said external high-pressure resistant woven cover comprises a first and a second tubular jacket configuration, one disposed concentrically inside of the other, each formed of a woven fabric, wherein pairs of warp threads run longitudinally and single weft threads run helically with respect to the warp threads, with the weft threads of said first jacket and second jacket extending helically in opposite directions with respect a longitudinal axis.

24. The porous high-pressure resistant woven cover according to claim 17, wherein
said external high-pressure resistant woven cover comprises a first and a second tubular jacket configuration, one disposed concentrically inside of the other;
said first tubular jacket formed of a woven fabric, wherein single warp threads run longitudinally and the weft threads run helically with respect to the warp threads;
said second tubular jacket formed of a woven fabric, wherein pairs of warp threads run longitudinally and single weft threads run helically with respect to the warp threads; and
said weft threads of said first jacket and second jacket extend helically in opposite directions with respect a longitudinal axis.
